(19) United States
(12) Patent Application Publication
(10) Pub. No.: US 2009/0281941 A1
(43) Pub. Date: Nov. 12, 2009

(54) System and Method for Managing the Generation, Collection and Distribution of Contributions from the Use of Payment Cards

(76) Inventor: Julian Otto WORTH, Lauenen bei Gstaad (CH)

Correspondence Address: STURM & FIX LLP, 206 SIXTH AVENUE, SUITE 1213, DES MOINES, IA, 50309-4076, US

(21) Appl. No.: 12/343,962

(22) Filed: Dec. 24, 2008

(30) Foreign Application Priority Data
May 6, 2008 (IB) PCT/IB08/51756
Jul. 9, 2008 (EP) PCT/EP08/58886

(51) Int. Cl. G06Q 40/00

(52) U.S. Cl. 705/39

(57) ABSTRACT

A system and method for managing the generation and the collection of financial contributions from holders of payment cards (50) and for distributing the collected contributions among a plurality of beneficiaries selected by the cardholders. The payment cards (50) have a unique identification that is associated with a contribution factor (CF) representing the cardholder's selected level of contribution to be made in proportion to the amount of transactions made with the card. A selection of one or more beneficiaries such as charities, and where needed a distribution of these contributions among two or more beneficiaries is also associated with the card's unique identification. A payment card system (40) processes transactions in the normal way via a transaction network and provides data (43,45) that represent contributions proportional to the amount of transactions. The payment card system (40) provides data to pay contributions to a merchant account held by a contributions processing entity (20). The latter provides data (80) representing a distribution of the collected contributions amongst the beneficiaries selected by the cardholders. The cardholder can select or modify the beneficiary data and optionally the contribution factor through the system's Internet site (30). Collection and distribution of the contributions is simple and flexible and the cardholder can alter the beneficiaries without this requiring any modification to the cards (50) or their coding.

### FIELD OF THE INVENTION

This invention relates to a system and method for managing the generation and the collection of financial contributions from holders of payment cards and for distributing the collected contributions among a plurality of beneficiaries selected by the cardholders, in particular among different charities.

### BACKGROUND OF THE INVENTION

The use of credit cards for collecting charitable donations has already been proposed.

Charity cards are not a new concept. Many banks and card companies issue them. Typically, when the cardholder uses the card, the bank or card company will donate a small fraction of the user's expenditure on that card to charities, usually of the bank's choice. Alternatively they might donate a fixed amount per transaction. The donation in this case is given by the bank or Issuer and not by the Cardholder.

There also exists a system whereby, by virtue of a specific processing system for credit and charge card users, a card issuing company or bank is able to donate a fraction of its own revenues—driven by cardholder expenditure—from such cardholder transactions. This is effected by the cardholder using a bank or card company-issued card that identifies which charities the cardholder prefers the bank's donation to go to, by the processing company or transaction network identifying data contained in the magnetic strip on the reverse of the card.

Along these lines, U.S. Pat. No. 5,466,919 proposed a method which enables a credit cardholder to make a donation to a cardholder-selected charity any time he makes a purchase using the credit card. The credit/charge card identifies on its magnetic strip a charity account to receive a donation. The card user's transactions are transmitted in a network transaction processor. Those transactions involving donations are identified by the presence of the charity account from the card's magnetic strip, and are processed in a dedicated transaction processor, whereas transactions that do not involve donations are treated separately in a standard processing biller. The donated amounts may be paid by the bank or card issuing organization, or the cardholder may add an amount which he pays to the selected charity. However, if the cardholder wishes to change the charity, this implies a change in the card's magnetic code. Moreover, the split billing system for transactions with or without donations creates additional work for the credit card transaction processor.

U.S. Pat. No. 6,088,682 describes a system and method for handling point-of-sales transactions to allow consumers to donate change from transactions to charity accounts.

U.S. Pat. No. 5,546,303 describes collecting charitable contributions at vending stations from where data on the contribution is transmitted to a central location.

US Patent publication 2004/0024698 describes a method of channeling funds to a plurality of charitable organizations using a credit card system where the credit card contains a blind identifier of a charitable organization.

### SUMMARY OF THE INVENTION

It is an aim of the invention to provide a system and method of the mentioned type for managing the generation and the collection of financial contributions or donations from holders of payment cards and for distributing the collected contributions among several beneficiaries such as charities selected by the cardholder, where the level of contributions is pre-selected by the cardholder and processing of the collection of contributions at the level set by the cardholder is simplified, and distribution of the collected contributions is easy and flexible in that the cardholder can change whenever he desires the beneficiary or beneficiaries of his contributions and if desired the distribution of the contributions amongst different beneficiaries, without any need to alter the card or its coding.

Management systems of this type can constitute part of a payment card system comprising an institution that issues payment cards to cardholders and wherein transactions using the cards are processed via a transaction network, wherein the cards are each associated with a unique identification, typically in the form of a numeric or an alphanumeric sequence. The payment card system has a data processor that is connectable to points-of-sale via the transaction network for processing transactions made with the payment cards, preferably including the payment of merchants through merchant accounts, and for providing to individual cardholders statements of transactions made using the individual cardholder's payment card.

Details of such payment card systems and their transaction networks are for example described in U.S. Pat. No. 6,014,635, where the payment cards are referred to as transaction cards.

According to the invention, a management system of the aforementioned type is characterized by the following features.
(a) It comprises a set of payment cards for cardholders who elect to make contributions in proportion to the transactions made using the cards, each of these cards being associated (i.e. electronically, in the payment card system, not physically in the card itself) by its unique identification with a contribution factor that is selectable by the cardholder, representing the cardholder's selected level of contribution to be made in proportion to the amount of transactions made with the card.
(b) It comprises first data processing means that stores data on the contribution factors along with the unique identifications of the respective contribution cards.
(c) The first data processing means is arranged to generate, for each cardholder having a payment card associated with a contribution factor, output data indicating a cardholder contribution that is a proportion of the value of transactions made by the cardholder according to a level set by the contribution factor associated with the card.
(d) The cardholder-contribution output data from the first data processing means is treated as or delivered to or charged as a merchant account held by a contributions management entity whereby the cardholder contributions are payable by data transfer to the contributions management entity via its merchant account.
(e) The contributions management entity has second data processing means for receiving and processing the following data:
   data on the unique identifications of the payment cards associated with contribution factors,
   cardholder-contribution output data from the first data processing means,
   beneficiary data that identifies a plurality of beneficiaries, and
   distribution data indicating those beneficiaries that have been selected by the cardholders, and where needed a distribution amongst several beneficiaries selected by a cardholder, this distribution data being associated with the unique identifications of respective payment cards.
(f) This second data processing means is arranged to output data which represents a distribution to the different beneficiaries of the contributions made by different cardholders according to said distribution data.
(g) Lastly, the management system further comprises data input means for enabling cardholders to select one or several beneficiaries or to alter their selection of beneficiaries and where needed to select or to alter the selection of the distribution of contributions amongst several beneficiaries, all in association with the unique identifications of their cards, to constitute or to update said distribution data of the second data processing means.

Overall, the system is arranged whereby the first processing means is operative to provide data representing contributions proportional to the amounts of transactions at a level selected by each cardholder, and the second data processing means of the contributions processing entity is operative to provide data representing a distribution of the collected contributions amongst the beneficiaries selected by the cardholders.

The inventive system thus manages the collection of financial contributions from cardholders and distributes the collected contributions among several beneficiaries selected by the cardholders in a simplified manner (it being understood that each cardholder may select one or several beneficiaries).

The inventive system overcomes the limitations of known charity card arrangements and makes possible widespread charitable contributions using well-known and accepted payment cards. The invention's large-scale collection of charitable contributions using payment cards would be unfeasible for the charities to organise themselves. The invention thus creates a certain economy of scale that could not be reached in the context of a sole charity issuing cards for its sole benefit.

Contributions or donations are charged to the cardholder at a level set by the cardholder, and proportional to the amounts of transactions. Preferably, the contribution factor for a payment card is selectable at a level chosen by the cardholder before the card is issued, and has a selected fixed value when the card has been issued. Alternatively, the cardholder can select and alter the contribution factor by interacting with the system's data input means, usually its Internet site.

All transactions with the cards, including donations, can be processed in the normal manner as for known credit cards or other payment cards, i.e. payment of the donations is handled in exactly the same way as payments to the merchants registered with the payment card system. This implies a great simplification for the payment card processor, compared to having separate payment processing for donations and for normal transactions. However, different ways of processing the transactions can be contemplated.

The first data processing means can be part of the data processor of the payment card system (payment card processor and/or transaction card authorization and clearance system such as VISA™ or MasterCard™); or it can be part of the contributions management entity; or it can be a separate unit that cooperates with said data processor of the payment card system and with the contributions management entity.

The fact that the data on the card's contribution factor (also the beneficiary data) is held by the payment card system, not by the card, enables great flexibility in implementation of the inventive system, and for example implies that the system can be applied both to new cards to be issued and to existing issued cards as well as replacement cards.

The first processing means of the payment card system preferably processes the transactions in the usual way and provides an indication of the contributions to be paid by the cardholder, along with the periodic e.g. monthly statements of all transactions made by a cardholder. Upon receipt of these statements, the cardholders pay in the usual way.

Thus, in the first data processing means, which can be part of the institution that processes the card transactions, the contributions/donations at the given level are treated as a merchant account. The contributions are collected for all of the different cards of different cardholders, and accumulated in the merchant account. Thus all of the contributions/donations are paid over to the contributions management entity.

The accumulated donations are then processed by the second processing means of the contributions management entity/organization to distribute the donations amongst the beneficiaries selected by the cardholders, typically various charities. These beneficiaries/charities can be selected at will by the cardholders interacting with the above-mentioned data input means of the system, which preferably is embodied by an Internet site accessible to authorized cardholders. Thus the cardholders can select a designated charity or charities or change the designated charities, or the distribution of donations between two or more selected charities, at any time and without any need to change or alter the card or its coding. This Internet site can advantageously be arranged to provide statistics relating to the contributions of cardholders and to the contributions distributed to beneficiaries, these statistics being accessible to authorized cardholders and the participating charities or other beneficiaries.

The inventive system implies advantages for all participants. For the beneficiaries (charities) the system represents a cost-effective means of raising money on a continuous basis that could not be achieved by individual initiative. The beneficiaries/charities would be seen as endorsers of the system. They do not have to advertise on behalf of the system which will avoid conflicts as regards their own fund raising initiatives. For the cardholders, the system provides an easy and practical means of giving to charity. Furthermore, the cardholders have the ability to change preferences from time to time and to respond to international aid occurrences. Involvement of card processing companies in the system delivers increased processing volume and revenues. The issuer of a branded card will for example not only increase his billing volume from clients that move to the system's card, but could also win customers from other issuers and processing companies. Participating issuers will also increase their processing volumes according to how many cardholders register their existing cards at the system's website.

As mentioned, the beneficiaries are for example charities, but could also include political parties, sports teams, environmental or other activist groups, aid agencies and organizations, or organizations that raise funds in case of disasters all of which may be Government or Non-Government bodies. The beneficiaries can be grouped in sub categories, such as “Poverty-Related Charities”, Famine-Relief Charities, “Children's Charities”, “Disability”, “Environmental”, “Homelessness”, “Hospices”, “Medical and Health”, “International Aid”, “Animal Shelters and Charities”, “Arts and Culture”, and so on. In the case of International Aid Charities, the cardholder will be able to quickly modify his charity choice online in the event of a disaster. The beneficiaries may even be for example personal savings accounts for the benefit of individual cardholders. The contributions management organization or another entity managing the system will keep a list of beneficiaries/charities that can be selected by the cardholders, and it is possible to add new beneficiaries to the list for instance at the request of new cardholders. There can be different lists of beneficiaries for different countries or areas. The contributions management or organizing entity can regularly update the website with new beneficiaries/charities that join after their application has been approved. It is also possible to provide for prospective beneficiaries/charities to apply on-line at the systems website and undergo an on-line or off-line approvals procedure.

It is possible that a single contributions management entity receives cardholder-contribution data from the first data processing means of one financial institution that processes transactions with payment cards, or from several different first data processing means each associated with a different financial institution that processes transactions with payment cards. In other words, the contributions from several card-processing institutions (e.g. several different types of credit or debit cards or other payment cards) can be processed centrally by one contributions management entity.

The invention also pertains to a corresponding method.

In one aspect, which covers the activities of the payment-card processing institution, the invention proposes a method for managing the generation and the collection of financial contributions from holders of payment cards for distributing the collected contributions among a plurality of beneficiaries selected by the cardholders, in a management system as discussed above, the method comprising issuing new cards each associated with a unique identification that is associated with a contribution factor chosen by the cardholder, and/or associating the unique identification of existing issued cards with a contribution factor chosen by the cardholder.

When the method involves issuing new cards, the card-issuing entity will transfer to the first data processing means and to the contributions management entity the data on the contribution factors of the respective cards along with their unique identifications.

When the method involves associating a contribution factor chosen by the cardholder with the unique identification of an existing card, this can be achieved by the cardholder entering his card's unique identification in the system's data input means (usually the system's website) and then selecting a contribution factor (and optionally at this stage, or later at the system's website, a distribution of the contributions amongst different beneficiaries). In this case, the system's data input means (usually the website) will transfer to the first data processing means and to the contributions management entity the data on the contribution factors of the respective cards along with their unique identifications.

This method can also comprise the following steps:
storing, in the first data processing means, data on the contribution factors along with the unique identifications of the respective payment cards;
the first data processing means generating, for each cardholder having a payment card associated with a contribution factor, output data indicating a cardholder contribution that is a proportion of the value of transactions made by the cardholder according to a level set by the contribution factor associated with the card;
treating the cardholder-contribution output data from said first data processing means as a merchant account, or delivering said cardholder-contribution output data to a merchant account held by a contributions management entity whereby the cardholder contributions are payable by data transfer to the contributions management entity via its merchant account; and
transferring cardholder-contribution output data from the first data processing means to the contributions management entity.

In another aspect, which covers the activities of the contributions management entity, the invention proposes a method for managing the distribution of collected contributions among a plurality of beneficiaries selected by the cardholders, in a management system as discussed above, the method comprising receiving and processing the following data on the second data processing means of the contributions management entity:
data on the unique identifications of the payment cards that are associated with contribution factors,
cardholder-contribution output data from said first data processing means,
beneficiary data that identifies a plurality of beneficiaries, and
distribution data indicating those beneficiaries that have been selected by the cardholders, and where needed a distribution amongst several beneficiaries selected by a cardholder, this distribution data being associated with the unique identifications of respective payment cards;

and outputting data from the second data processing means, which output data represents a distribution to the different beneficiaries of the contributions made by different cardholders according to said distribution data.

In yet another aspect, which covers the activities of the cardholders, the invention proposes a method of generating financial contributions from cardholders for distributing the collected contributions among a plurality of beneficiaries selected by the cardholders, in a management system as discussed above, the method comprising the following steps taken by a cardholder holding a payment card associated with a contribution factor that is selected by the cardholder, representing the cardholder's selected level of contribution to be made in proportion to the amount of transactions made with the card:
making transactions with the card in order to make contributions in proportion to the transactions made using the cards; and
constituting or updating said distribution data of the second processing means using said data input means of the management system to select one or more beneficiaries or to alter the selection of beneficiaries and where needed to select or to alter the selection of the distribution of contributions amongst two or more beneficiaries.

The invention also proposes an overall method for managing the generation and the collection of financial contributions from holders of payment cards and for distributing the collected contributions among a plurality of beneficiaries selected by the cardholders, in a management system as discussed above.

The payment cards used in the inventive system and method can be a credit or a charge card, but equally a debit card which would normally be issued by a bank in connection with a customers account. A dual purpose (debit and credit) version is also contemplated.

A credit card transaction offers cashless payment where the cardholder settles sometime after purchase. There is usually a predetermined credit limit. Well known brands of credit cards include VISA™, MasterCard™, American Express™, JCB™ and DISCOVER™.

Charge cards offer cashless payment with no particular credit limit but payment is timed later than the purchase transaction. Payment is normally due at month/billing period end. Well known brands of charge cards include American Express™ and Diners Club™.

A debit card and related transactions are linked directly to the cardholder's bank account, usually at the issuing bank and any transaction is thereafter immediately debited from that account. Well known brands of debit cards include Maestro™, Switch™ and Cirrus™ (ATM).

In case of dual purpose cards, which can also be used in the inventive system, a single card may be issued giving the holder the choice of transaction type each time the card is presented. This card may be issued by a bank or other institution.

The invention also applies to pre-paid cards which are a type of debit card.

The invention also applies to payment cards issued for example by chain stores for purchases only in their own establishments. Such cards frequently offer discounts or other advantages and are sometimes referred to as “fidelity cards”.

The payment cards used in the inventive system are compatible with all standard transaction types in the way that cards are presently processed, in particular the payment cards can be used in connection with all usual transactions including the purchase of goods and services and cash withdrawals.

The unique identification of the payment cards can for example be an identification number like a regular credit card identification number, made up in particular of a first sequence of numbers representing a bank identification code, a second sequence of numbers representing a cardholder identification, and a control number. However, alphabetic symbols can be included in the unique identification, if required, or other types of unique identification can be used. For example, the payment cards of the inventive system can be regular payment cards identified by their unique identification in the form of a numeric or alphanumeric sequence, and that do not need special coding.

Typically the payment cards used in the inventive system will be substantially-rectangular plastic laminates made to standard dimensions (e.g. ISO/IEC 7810 standard as 85.60×53.98 mm and 0.76 mm thick) and will include a standardized magnetic stripe in which data including the card identification is encoded. The cards can also be smart cards with an integrated storage chip (a system known in some markets as “Chip and PIN”). These cards are compatible with standard card readers, such as “swipe” or “push-in” which are connected either by cable or wireless means to a communications network in order to access the relevant transaction network computer system. The plastic cards can have an embossed identification number as is usual for credit cards, making them usable also with the old-fashioned slide-over devices for taking a card imprint.

Alternatively, the card can be a virtual card for example incorporated in an electronic device such as a mobile phone, a “smartphone” or a PDA. The card type may also be for example what is known as contactless or “Wave and Pay” where the card incorporates a miniature RF emitter that emits a radio signal as the user passes a detector in a store. Such systems are useful for large volume small value purchases such as in supermarkets etc. The term for such card types is sometimes referred to as “Near Field Communication” or “NFC”. Regardless of the precise payment card type used such card types or virtual card type used will be adapted for making payments via a transaction network and will always be associated with an unique identification known to the system and by means of which it can be associated with a contribution factor stored in the system, and also optionally has a personal identification code such as a PIN code known to the cardholder and the system.

For a user to register his existing card on the system he will need to be aware of his own card number constituting the unique identification. Where the unique identification is only in the chip and not on the card, the user need only know the security access such as a PIN code.

The payment cards used in the inventive system and method can be used in the usual way for all types of transactions usually carried out with the payment cards. This includes, on the one hand, point-of-sale transactions where the card is passed in a swipe or push-in reader that reads the card number from the card's magnetic stripe and transmits the number and other data to the card-processing entity via the transaction network and, on the other hand, Internet transactions where the cardholder keys in the card number, expiry date and possibly a security code. The latter was not possible with the above-mentioned method of U.S. Pat. No. 5,466,919.

Cards with an integrated storage chip and those incorporated in electronic devices are particularly useful for securised transactions typically using a personal identification code such as a PIN code, such transactions including direct debit.

Other secure means of access to use the cards include biometric techniques such as fingerprints, iris recognition and so on.

If it were considered desirable (for data processing purposes which may vary from country to country) that the identity of the cardholders not be known to the system manager or the contributions distribution entity, passwords giving access to the system's website may instead be issued by the card issuer. The system manager or the contributions distribution entity will have a record of the association between the password and the card unique identification, which is sufficient for its purposes.

The invention is designed to enable holders of the inventive card to systematically donate to charities of their choice on a continuous basis, according to a predetermined level of overall card spending, and divided among the user's chosen charities with simplification in the management of the collection and distribution of the donations.

Linking charitable donation to personal expenditure allows us to “passively” and conveniently do something that many people want to do, but never find the time for. It seems to be a fair and “just” concept to link how much we give to charity to how much we spend on ourselves. The inventive payment card process allows the cardholder, by virtue of a combination of potentially one-off instructions or actions, to do this, while the processing of payment card transactions can remain the same as for known payment cards and distribution among selected charities takes place according to the cardholder's selection that can be registered or updated without any change to the card.

The result of widespread distribution and adoption of the inventive payment cards will be to produce significant charitable fundraising of a level that could not otherwise be achieved and in a convenient and “hassle-free” manner. The technical methodology to be employed facilitates, among other things, fund raising, and charitable funds distribution, by largely eliminating human administration (and the associated high cost of this function currently borne by the charities), and replacing it with a cost-efficient, user-friendly, web accessed platform that is accessible and controllable by the cardholder (donor).

The user's choice or “level” of payment card combined with a potentially one-off set of instructions given by him online at the system's website, drives the collection, distribution and subsequent investment of his donations.

Although initially aimed at the private user, the inventive system's payment cards may attract interest from companies as it would allow employees using a company card to have a say in where corporate donations were directed. Employees may indeed consider this to be an indirect “perk”.

The inventive system eliminates much of the repeat marketing and advertising costs incurred by charities, which are required to create continuous awareness of their particular cause. As such the system is likely to be vigorously promoted by the charitable organizations associated with the programme.

The inventive payment card system also involves the following elements.

An issuing company will in the first instance offer (via its credit/charge card issuing and licensed processing partners) the invention's card for example as a branded payment card. This card is to be offered as a replacement of the users usual Credit/Charge card/or other payment card, and provides the user with the practical means to donate to charities of his choice, according to preset criteria, in an efficient and cost effective manner, and importantly as a direct proportion of his card spending.

The system can be operated by a single company or a conglomerate or consortium, in which case the card issuing entity can be the same as the contributions management entity, or they can be different divisions of the same entity. It is also possible for the system to be run by a joint venture or group of companies or other entities, in which case one or more separate card issuing companies, one or more card processing companies and a contributions management entity may all cooperate with one another and use a common website.

Generally, the inventive system can be incorporated in existing payment-card organizations without any change in the card-processing operations. For example, the invention can make use of available communications networks like the VisaNet™ network that links banks and participating merchants and perform applications including:
Transmitting real-time authorisation requests and approvals;
Carrying out clearing and settlement between member banks;
Stand-in processing services, such as taking authorisation decisions on behalf of card issuers, according to preset parameters; and
Other services such as cardholder authentication, fraud screening and transaction storage and retrieval.

Transactions using the payment cards will be possible wherever the Transaction Processing Network (such as VISA™) featured on the Card, is accepted. The cards used within the context of the inventive system are designed for use with all known payment card types that are used within the usual network processing environment.

In one embodiment of the invention, the payment cards of the inventive system and method will be seen to be issued by the given issuing company, and the cardholder experience will be in a completely branded environment. In practical terms, all aspects of processing (credit checks, card issuance, billing and cash collection), is to be carried out by partners in the various territories in which the system is operated.

However, branding of the cards is not essential. In particular the holders of already-issued cards can participate in the system using their existing cards that can, if the cardholder so desires, later be exchanged for branded cards of the inventive system when the cards are replaced. Alternatively the cardholder may elect to continue to use his existing card (which may in any event be replaced from time to time by the issuer) without any such branding. Where existing payment cards are utilized in this manner, the unique data provided by the cardholder when he registers his card (for example in the form of the card's numeric or alphanumeric sequence) enables the system to alert the cardholder's particular issuer to the fact that he wishes to be billed with the appropriate uplift in future. Equally, upon registration of existing cards, the user can be presented with the choice of remaining with an unbranded or branded card upon replacement.

Generally speaking, the inventive system thus applies to branded cards issued by the system, to the registration of existing cards under the existing card's brand, and to co-branded cards that carry the system's brand along with another brand for instance where the card is enabled to participate in the inventive system by the user registering it at the system's website. It is anticipated that there will be only one issuer of fully branded cards in a territory. However this same issuer of fully branded cards can also issue co-branded cards along with a number of additional issuers. There is no need for exclusivity for the co-branded unbranded level.

The money raised as a result of the above card-related turnover, is to be distributed among the participating charities that may have either been invited or nominated to be part of the programme. These funds can be aggregated, invested and later distributed to the subscribing charities, by using the same and/or related data that has been previously created by the cardholder and resides on the system's web-accessed database. Thus, as an optional service, the contributions management entity (or other operator of the management system) may also act as financial intermediary and invest funds on behalf of the charities in a variety of investment funds created by its partner banks and that can be managed independently of the inventive system.

These payment cards can be offered in a variety of levels (for example, Blue, Silver, Gold, Platinum Diamond, etc) to users, wherein each card type/level denotes a different level of overall donation, or percentage monthly card statement “uplift”. For example, and in the case of payment cardholders carrying the Blue card, this might add 2½% to the cardholder's monthly bill, Silver card, 5% to the total monthly bill of the user, Gold card 7.5%, Platinum 10%, Black Card 15%, and VIP card with a contribution level at a given value typically above the maximum 15% set by the individual cardholder, etc. Another possibility is to allow the cardholder to freely choose the level of contribution by entering the information on the system website. This might for example be more useful in the case of already held unbranded cards where the association of card and tier/colour were not needed.

These levels and their association with card colour/status are preferably to be predefined. The card status can be identified by the colour of the card or of a part of the card, for instance the colour of a logo/trademark that identifies the inventive system. Preferably, the system's logo will be placed somewhere on the card, usually with a given size and at a given location but possibly in different colours depending on the status.

Cards can be made available to the public in (but not necessarily limited to) VISA™, MasterCard™ and Amex™ versions, in order to cater for user preference/brand loyalty. Debit cards and dual purpose cards issued by the card issuer or partner Banks can also be available in a variety of industry standard transactional-platforms versions used to settle debit card transactions.

The various steps for implementing the inventive System are for example as follows:
The prospective Cardholder applies for a Card and at the same time indicates the card level/colour he wishes to use i.e. the overall “uplift” he wishes to donate and that will be billed to him at month end.
The usual credit checks are carried out by the card issuer and under normal circumstances, a card is issued.
When the card is issued to the cardholder, he is given password protected access to the system's website where he may give instructions as to how the pre-determined overall “uplift” is to be divided. This information is private and accessible only by the holder of the password, and the contributions management entity. He will choose one or more charities from a variety of charities that already participate in the programme as well as optionally being able to nominate specific charities he wishes to include in the programme. The system's website will also provide the option of the cardholder choosing from “theme funds” rather than having to individually choose. Multiple card users on the same account may have separate access to the system's website and may have different donation instructions to each other.
Optionally, the initial registration of a cardholder can be done manually by the cardholder filling a form and submitting it to a system operator who issues the card and identifies the cardholder's selected charities, or as a default may issue the card with a pre-set charity or charities that are entered in the database and that the cardholder can change by accessing the system's website.
The holder of an existing payment card can also request inclusion in the inventive system by logging in his card's unique identification number into the system's website, choosing a level of contribution to set the contribution factor, and allocating the distribution of the contribution to one or several charities.
The cardholder uses the Card for all types of card purchases. This includes the usual purchase of goods or services or any other payments, and can also include other charges like cash withdrawals using the card.
At month end (or billing period end) an “uplift” amount is added to the cardholder's statement in accordance with the percentage “uplift” associated with the card level. This “uplift” is billed to the cardholder and the charge appears on his next statement.
The cardholder settles his (enhanced) card bill in the normal manner, for example by cheque, direct debit etc as per cardholder agreement.
The Card processing partner settles the “uplift” charge (by paying the contributions management entity) in the same manner as if it were a regular merchant.
Upon settlement of the uplift charge, each individual incoming payment is associated with the cardholder by means of data transferred simultaneously by the processing partner. Uplift amounts could be charged and remitted on a daily or as incurred basis but it is deemed more practical to carry out this process once a month.
The data held on the system's website (previously provided by the Cardholder and variable by the cardholder from time to time) enables the contributions management entity to allocate the “uplift” received among the cardholder's chosen charities. Such data provided by cardholders need not necessarily contain the name of the cardholder. All that is required is the association of the card's unique ID with that card's beneficiary distribution instructions. In this way, incoming payments made from the card Processing company that are associated with a particular card may be dealt with according to the cardholders preferences, whilst the cardholder may remain anonymous in the eyes of the contributions management entity and his own card issuing company. There is no need for a new card to be issued if the cardholder wishes to change his charities or distribution of his “uplift” as the data needed for this function is provided online and associated with the user's card number. In the example of a branded or co-branded payment card, the only time a card change would be required is if a cardholder elects to change his overall level of “uplift”—as this is associated with the card colour or level he carries. In the case of unbranded cards, there would be no mandatory card change necessary.
Registration on the system can be facilitated by the system's website being linked on the websites of existing payment card organizations like VISA™ or MasterCard™ and by these and/or the system's website providing information about how to sign up for a branded card and how to register an existing card.

NB: In the case of debit cards issued in connection with a user's bank account, a fixed day of each month may be used to determine the uplift billing time.

Using Existing Payment Cards with the Inventive System

Cardholders wishing to adopt the inventive system using their existing payment cards, (Credit, Debit, Charge, ATM etc) may do so by registering their existing card at the system's website, using its unique identification. The cardholder's issuer will be notified of registration. This function will only be possible where the card was issued by an issuer that participates in the inventive system, which should be the case for most issuers.

(Note: In the case of Debit Cards associated with checking account customers of banks, the relevant uplift charge will appear on the account statement at a time of month to be determined by each bank.)

When the cardholder of an existing card applies to register, the cardholder may choose any level of uplift, possibly with a minimum value, or he may choose fixed percentages set by the issuer, depending on the issuer's policy. Once registered on the system's website, data will be transmitted to the card issuer so that the relevant card issuer/processing company knows by what percentage to bill the uplift at the billing period end. The system operator or contributions management entity does not need to know the identity of the cardholder. The unique identification associated with the card is sufficient. The systems website can provide a password to the cardholder that will enable him/her to access the site and profile his/her account.

It can be expected that in the long run, many existing cards that are registered into the system in the above-described way will be exchanged for branded cards carrying the system's logo.

System for Aggregating, Investing and Distribution of the Charitable Donations or “Uplift”

The uplift that is remitted and collected is aggregated with other “uplift” amounts from all cardholders regardless of whether the cards were credit, charge, debit or dual purpose. The aggregated uplift can then be remitted to partner bank(s) after a commission is taken. This commission represents a fee and effectively forms part of the overall cost to the charities of the system's services.

Using information from the same database, and made available to the partner bank this time, the partner bank accounts for the inflow of funds in terms of which charities benefit and to what extent. Alternatively, it may be all parties that retain this data. For example, the money is held within a fund where it is managed and invested according to predetermined parameters, and at this time may not yet be remitted to the individual charities, according to the charity agreement terms.

In a preferred implementation, once a certain aggregated amount has been raised a fund is closed and each charity implicated becomes part owner of this fund to the extent of its pro rata share (how much net money has been raised on its behalf). As this is a continuing process, further funds raised are treated in the same manner but go into subsequently created funds. Each fund is closed at the same value, in order to promote a regular and even maturity process.

Each fund will for example be closed for a period of time during which it will be managed by the partner bank(s). The partner bank(s) and the contributions management entity may derive further revenue from this function. Although the money raised and held in the funds is not available to the participating shareholder (the charities) until each fund matures, it would be possible to offer loan-backs to the charities, if required, using the money raised on behalf of that charity, as collateral. This provides early liquidity to the charity and a further potential revenue stream.

Notwithstanding the above, when a fund matures, each shareholder (charity) will receive back its (inflated) pro rata share. All fund monies will be held in third party trust accounts and will be ring-fenced from the ordinary activities of the managing bank(s).

In a simplified alternative implementation, the contributions management entity would be the exclusive fund manager for all money raised for the charities and would manage these funds in accordance with set conditions.

In a further simplified implementation, the contributions management entity may offer the beneficiaries, who will be mainly charities, the option of receiving the funds raised on their behalf directly from the contributions management entity on a regular basis, or the option of the contributions management entity investing such funds on their behalf with its third party banking partners.

Costs/Fees of the System

The costs of running the system can be borne by:
Fees for the issuance of the payment cards (branded payment cards).
Fees or commissions in respect of the contributions (uplift).
Membership fees for participating charities.
   It would be possible to provide for a refundable membership fee for participating charities, that would be refunded in case the money raised for that charity did not reach a target figure in a given time.

Additional Functionality of the Technical Platform and Process.

At all times both the donors (cardholders) and the charities have password-protected online access to the system's website and may see in real time, among other things:
a. How much a cardholder has contributed in total and broken down by charity (access to this information can be organised in such a way as to provide data to the individual, the charity etc. according to chosen parameters).
b. How much in global terms the system's endeavours have achieved. The global program that the cardholder is a part of, viewable by cardholder and charity again depending on chosen parameters.
c. How much is/has been raised for a particular charity, or all charities in aggregate etc (charity view and card holder view for example). Charities will be able to see how their competitors are performing, and may for example use this information to modify or devise their future marketing strategies, as they are effectively operating in a competitive arena.

The cardholder may elect to have partial or complete anonymity vis-a-vis the charity(ies). He may also elect to have temporary anonymity, which may be removed by him by disassociating his card with this function, later. The databank will retain a record of all donations made during the period of anonymity and otherwise.

In a further example the cardholder may elect to associate the “nature of his expenditure” with the charity (or types of charities) to which the relevant uplift is to be directed. For example, the cardholder may elect during the “set up” process, to direct the uplift created as a result of all expenditure he makes in restaurants, to “famine” related charities (“World Food Programme” for example). There are many charities that the cardholder may elect to associate with the “uplift” (or part of the uplift) created by his expenditure in “related” areas. This level of detail and association may be achieved, as card transactions are capable of producing the required data. Equally, a fund theme or default setting may be arranged around this concept, which may simplify the decision making process for users (“Relevant Expenditure Related Donation”). It is also possible that new branded cards are issued with this type of default setting.

Each country will have its own charities in the programme to which cardholders may donate. International charities with presences in several countries will be accounted for individually, and in aggregate, and may be viewed in both ways by cardholders and charities alike. Cardholders may be able to select any charity in any country. Data and marketing material provided by the charities will be viewable in a separate window, when activated, on the system's website.

Equally, user groups (for instance Corporate groups using corporate cards) could be defined in such a way as to access specific groups of charities on the system's website.

The contributions management entity will have merchant status with card transaction processing systems/networks such as VISA™, Mastercard™ and American Express™ and in the case of debit card/cash/ATM and dual purpose card processors, the appropriate organizations such as Maestro™ and Cirrus™.

Where relevant, the final shareholding ratios of the participating charities can be set as each fund closes, possibly via warrants or an appropriate financial tool.

The system's database may also be used to generate tax reports for the cardholder, enabling him to claim appropriate tax relief in respect of his donations and/or create a further “uplift” for the charities by “grossing up”. This function will vary from jurisdiction to jurisdiction.

The inventive system will be interesting to the participating processing companies. On the one hand these companies will gain business from their competitors as they migrate from other cards. Equally, the value of processing business in respect of their existing clients (via other cards) will be increased by the amount of ‘uplift’ created.

### BRIEF DESCRIPTION OF THE DRAWINGS

The invention will be further described by way of example with reference to the accompanying drawings, in which:

FIG. 1 is a block diagram of one embodiment of a management system according to the invention.

FIG. 2 is a block diagram of a modified embodiment of a management system according to the invention.

FIG. 3 is a diagram showing two arrangements for managing the collected funds.

### DETAILED DESCRIPTION

The invention provides a system and method for managing the generation and the collection of financial contributions from the holders of payment cards and for distributing the collected contributions among a plurality of beneficiaries selected by the cardholders, in particular among different charities.

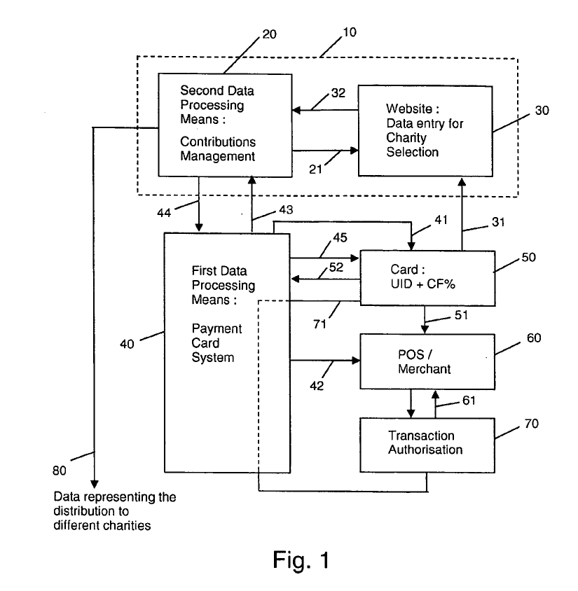

FIG. 1 schematically shows a payment card system according to the invention comprising an institution 10 that issues or authorizes the issue of payment cards to cardholders and processes transactions using the cards via a transaction network. In this example, the Card Processing Company (CPC) could be one of a plurality of Licensees of the Issuing Company 10 who issue IC-branded, (or possibly co-branded cards 50 in the case of bank issued debit cards) on behalf of the Issuing Company 10 according to territory. The CPC can be a credit/charge card issuing company in the case of credit/charge cards or a bank in the case of debit cards/dual purpose cards. Its functions are namely, having carried out any required credit approval processing: to issue the cards 50 as at 41, debit the cardholders account with the value of any purchases/transactions made, to uplift the value of any purchases by the contribution factor on record, to send periodic statements to cardholders in respect of card purchases and to collect money from the cardholders. In the case of debit cards, this will take the form of the issuing bank debiting the card holders bank account and in the case of credit/charge cards settlement will be made against periodic statements issued by the CPC and in accordance with payment card settlement terms.

The cards are for example credit cards or debit cards 50 each associated with a unique identification (UID) for example in the form of a numeric or an alphanumeric sequence. The card can be associated with a personal identification code such as a PIN or any other security access means such as biometric or fingerprint identification.

Electronic virtual payment cards can be used in the same way.

The payment card system has data processing means 40 (called first data processing means) that is connectable to merchants 60 and/or points-of-sale via its electronic transaction network for processing transactions made with the payment cards 50. This includes the payment of merchants 60 through merchant accounts indicated by 42. It also includes providing to the individual cardholders periodic, for example monthly, statements 45 of transactions made using the individual cardholder's payment card 50. In the case of debit cards, charges for purchases and any relevant Uplift are conventionally debited without credit terms to the bank account of the cardholder and these charges may be seen by the cardholder on his (monthly) bank statement.

The cardholder pays the payment card system manager as indicated at 52, under the usual conditions for the type of payment card. In the case of bank debit card use, the charges will appear as debits on the users relevant bank account statement.

As described above, the inventive management system comprises a set of payment cards 50 issued or to be issued to cardholders who elect to make contributions in proportion to the transactions made using the cards. Each of these cards 50 is associated through its UID with a contribution factor (CF %) that is selectable by the cardholder, representing the cardholder's selected level of contribution to be made in proportion to the amount of transactions made with the card. This contribution factor could for example be 2.5%, 5%, 10%, 15% etc and may be selected by the cardholder at a fixed level.

The first data processing means 40 stores data on the contribution factors (CF%) along with the unique identifications (UIDs) of the respective contribution cards 50. This data can be entered when the card 50 is issued or after the cardholder of an already-issued card has entered the data in the system's Internet site 30.

The first data processing means 40 is arranged to generate, for each cardholder having a payment card 50 whose UID is associated with a contribution factor CF, output data 43 indicating a cardholder contribution that is a proportion of the value of transactions made by the cardholder according to a level set by the contribution factor associated with the card. For instance, if the monthly spending with the card is [symbol] 1000.—and the contribution factor is 10%, the cardholder's monthly contribution will be [symbol] 100.—.

The cardholder-contribution output data 43 from the first data processing means 40 is treated as or delivered to a merchant account held by the contributions management entity, i.e. part of entity 10. Thus, the cardholder contributions are payable by data transfer (as at 43) to the second data processing means 20 of the contributions management entity via its merchant account. In this way, the cardholder contribution is payable to the contributions management entity at 43 in the same way as any merchant account, i.e. like a regular payment 42 to any other merchant 60. The card processing is the same for cards 50 associated with a contribution factor as for other cards. All payments by the payments card system manager are made to merchant accounts. With this example of the inventive system, there is simply an extra merchant account (43) associated with the contributions management entity.

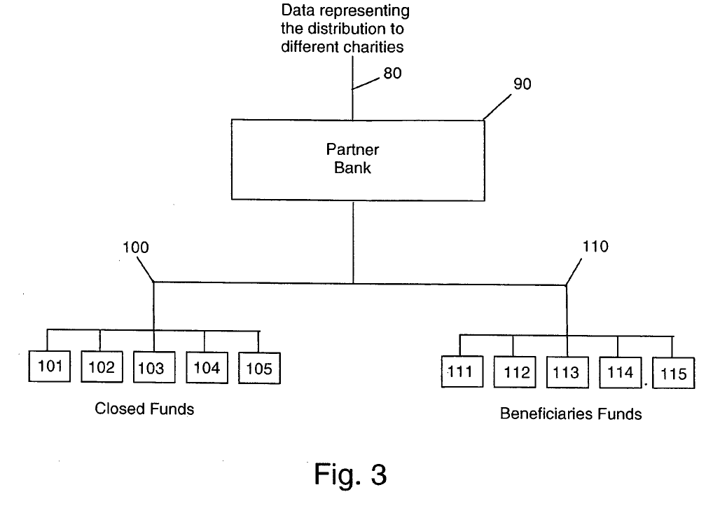

In the inventive system, the contributions management entity has second data processing means 20 for receiving and processing the following data: data on the unique identifications of the payment cards 50 associated with their contribution factors CF; cardholder-contribution output data (43) from the first data processing means 40; beneficiary data that identifies a plurality of beneficiaries (in this example represented by their funds 111-115, see FIG. 3); and distribution data 32, supplied from the system's Internet site 30, indicating those beneficiaries that have been selected by the cardholders, and where needed a distribution amongst several beneficiaries selected by a cardholder. This distribution data 32 is associated with the unique identifications of respective payment cards 50.

This second data processing means 20 is arranged to output at 80 data which represents a distribution to the different beneficiaries/charities the sum of the contributions made by different cardholders according to said distribution data.

The management system further comprises data input means in the form of the system's Internet site 30 for enabling cardholders to select one or more beneficiaries or to alter their selection of beneficiaries/charities and where needed to select or to alter the selection of the distribution of contributions amongst two or more selected beneficiaries/charities, all in association with the unique identifications of their card 50, to constitute or to update the distribution data 32 supplied to the second processing means 20.

If desired, the Internet site 30 can also allow the cardholders to set the level of the contribution factor CF.

The second data processing means 20 also inputs at 21 statistical data to the website 30 where authorized cardholders or beneficiaries/charities can view the statistics.

The illustrated system also includes a transaction authorization network 70, which typically would be provided by an organization like VISA™, MasterCard™ or Maestro™, which receives card data 51 when a transaction is initiated and carries out the usual transaction authorization at 61 and then authorizes the transaction at 71.

Overall, the system is arranged whereby the first processing means 40 is operative to provide data 43,45 representing contributions proportional to the amounts of transactions at a level selected by each cardholder, and the second data processing means 20 is operative to provide data 80 representing a distribution of the collected contributions amongst the beneficiaries selected by the cardholders.

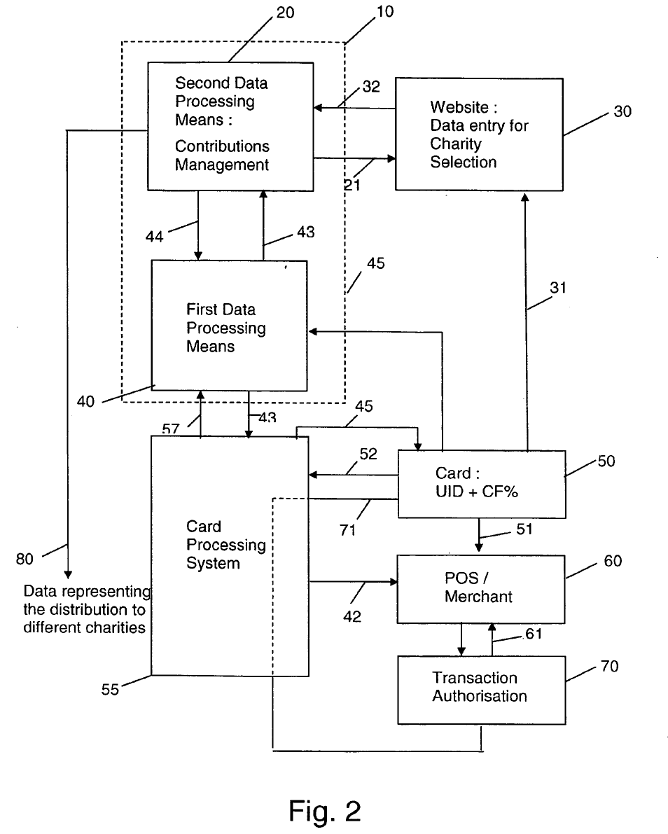

FIG. 2 shows a modified layout of the payment card system of the invention, wherein the same elements are designated by the same reference signs as in FIG. 1. In FIG. 2, the first data processing means 40 is separate from the payment card system designated by 55. As schematically indicated in dotted lines, the first data processing means 40 is unitary with the contributions management entity and with the second data processing means 20 as part of an issuing/management company 10. However, other arrangements are possible, such as having the first data processing means 40 as a separate unit that cooperates with the payment card system 55 on the one hand and with the contributions management entity on the other hand.

The arrangement of FIG. 2 enables the Payment Card System 55 to function in its normal manner as with conventional cards, whereas computation of the uplift associated with the different transactions is done externally of the payment card system using the first data processing means 40. For this, the first data processing means 40 receives data 57 from the card processing system 55 regarding the transactions carried out with the cards (or only with cards associated with a contribution factor CF), and also receives from the cards 50 (optionally via the website 30) information 53 on the UID's and CFs of the different cards 50.

The data 57 can be provided on a transaction-by-transaction basis or collectively, for example at month's end. The CME then charges the relevant card with the uplift amount (data 43) which because it is a card charge, may, unless pre-authorization has been arranged, be again authorized by the transaction authorization 70. Both the principal amount and the uplift are debited to the cardholder by the monthly statements 45. This example describes credit card use as opposed to debit card. Purchases are in principle debited on a transaction-by-transaction basis and the uplift can be debited in the same manner or at month end when the CME charges it based on the aggregate of all purchases made in the period.

Issuing of the statements 45 can be done by the card processing and transaction authorization unit or by individual card issuing entities of the card processing system downstream of the transaction authorization. In both cases, the payment card system 55 or the transaction authorization provides the data 57 to the CME or the first processing means 40 so that computation of the uplift is done externally of the card payment system (card issuer and transaction authorization) which relieves the card payment system of any need to modify its operation in order to compute the uplift.

The data generated by the transaction authorization (like VISA™) or by the individual card issuers contains all the data 57 required by the first data processing means 40 and the CME to compute and bill the uplift including the nature of the transaction so that the relevant expenditure related donation can be appropriated.

These alternative processing methods are relevant both for branded and existing cards.

In a modification of the system, the payment cards 50 are issued for example by a group of stores for making purchases only in stores belonging to the group. In this case the point-of-sales 60 do not represent a multitude of independent merchants but are outlets of the stores. One option is for the group of stores to manage its payment cards in a transaction system handling also other credit and payment cards.

Some companies for example store groups or airlines issue their own branded payment cards associated with for example the VISA™ or MasterCard™ system. They are generally operated by existing card processing companies. One of the main purposes is to market the company's brand. There may also be certain additional benefits associated with these cards that are particular to the issuer, such as points, miles etc. These cards may also be used wherever VISA, MasterCard or other association platforms are accepted. It is effectively a marketing tool. Some Store Groups also issue what are known as “store cards”. These are effectively the means of identifying a customer who holds a credit account with the store. In this example, the store will accept credit purchases made by the customer who would charge the invoice for goods purchased to his account. The store would then render for example a monthly bill, which would be sent to the customer. The customer will be expected to settle the full account or make a minimum payment. In this example the traditional transaction platforms such as VISA™/MasterCard™ are not being used, but it is the store's credit control system that is accepting/denying the transaction and processing it. Some store groups may outsource this function to credit companies or card processing organizations. In certain instances it is possible that the Store is receiving payment from a finance company in respect of these sales, in advance of the customer actually paying the monthly bill. There also exists a “dual-line” system using VISA™/MasterCard™ or similar, whereby credit limits for both the customer's (VISA™) account and his Store account (which may be different) operate independently. In the above examples, such Payment or Store Cards would in any event be capable of registration at the System's website in the prescribed manner and the Card Processing company (or Store) notified by the System's operator that the user had so registered his card, allowing the required uplift to be billed by the appropriate card processor.

FIG. 3 illustrates two possible arrangements for managing the contributions received. Data is output at 80 by the second data processing means 20, and which represents a distribution to the different beneficiaries of the contributions made by different cardholders according to the distribution data 32, is supplied to a partner bank 90. On the left of FIG. 2 is illustrated one arrangement 100 where several funds 101-105 each close at a given value, each fund being managed by the system's entity or its partners and distributed to the beneficiaries pro-rata according to their given share, after a give time when the fund reaches maturity. The right-hand part of FIG. 2 shows an alternative investment product where the partner bank 90 receives the output data and manages a series of databanks 111-115 each representing a fund and each in the name of one beneficiary, so that the fund of each beneficiary can be managed independently.

1. A system for managing the generation and the collection of financial contributions from holders of payment cards and for distributing the collected contributions among a plurality of beneficiaries selected by the cardholders, this management system being part of a payment card system comprising an institution that issues payment cards to cardholders and wherein transactions using the cards are processed via a transaction network, wherein the cards are each associated with a unique identification, the payment card system having a data processor that is connectable to points-of-sale via the transaction network for processing transactions made with the payment cards, preferably including the payment of merchants through merchant accounts, and for providing to individual cardholders statements of transactions made using the individual cardholder's payment card,
which management system is characterized in that:
(a) it comprises a set of payment cards for cardholders who elect to make contributions in proportion to the transactions made using the cards, each of said cards being associated by its unique identification with a contribution factor that is selectable by the cardholder, representing the cardholder's selected level of contribution to be made in proportion to the amount of transactions made with the card;
(b) it comprises first data processing means that stores data on the contribution factors along with the unique identifications of the respective cards;
(c) said first data processing means is arranged to generate, for each cardholder having a payment card whose unique identification is associated with a contribution factor, output data indicating a cardholder contribution that is a proportion of the value of transactions made by the cardholder according to a level set by the contribution factor associated with the card;
(d) the cardholder-contribution output data from said first data processing means is either treated as or delivered or charged to a merchant account held by a contributions management entity whereby the cardholder contributions are payable by data transfer to the contributions management entity via its merchant account;
(e) the contributions management entity has second data processing means for receiving and processing:
data on the unique identifications of the payment cards and the associated contribution factors,
cardholder-contribution output data from said first data processing means,
beneficiary data that identifies a plurality of beneficiaries, and
distribution data indicating those beneficiaries that have been selected by the cardholders, and where needed a distribution amongst beneficiaries selected by a cardholder, this distribution data being associated with the unique identifications of respective payment cards;
(f) said second data processing means is arranged to output data which represents a distribution to the different beneficiaries of the contributions made by different cardholders according to said distribution data; and
(g) the management system further comprises data input means for enabling cardholders to each select one or more beneficiaries or to alter their selection of beneficiaries and where needed to select or to alter the selection of the distribution of contributions amongst two or more selected beneficiaries, all in association with the unique identifications of their cards, to constitute or to update said distribution data received by the second data processing means,
whereby said first processing means is operative to provide data representing contributions proportional to the amounts of transactions at a level selected by each cardholder, and said second data processing means of the contributions processing entity is operative to provide data representing a distribution of the collected contributions amongst the beneficiaries selected by the cardholders.

2. The system of claim 1, wherein the contribution factor for a payment card is selectable at a level chosen by the cardholder before the card is issued, and has a selected fixed value when the card has been issued; or is selectable at a level chosen by the cardholder before or after the card is issued.

3. The system of claim 1, wherein said data input means includes an Internet site accessible to authorized cardholders.

4. The system of claim 3, wherein said second data processing means and/or said Internet site is/are arranged to provide statistics relating to the contributions of cardholders and to the contributions distributed to beneficiaries, said statistics being accessible to authorized cardholders and to authorized beneficiaries on said Internet site.

5. The system of claim 1, wherein the payment card system provides, from the cardholder contribution output data provided by the first processing means, an indication of the cardholders contributions along with statements of transactions made by the cardholder.

6. The system of claim 1, wherein said unique identification of the cards is in the form of a numeric or an alphanumeric sequence.

7. The system of claim 6, wherein said unique identification of the payment cards is an identification number, like a regular credit card identification number, comprising in particular a first sequence of numbers representing a bank identification code, a second sequence of numbers representing a cardholder identification, and a control number.

8. The system of claim 1, wherein a single contributions management entity receives cardholder-contribution data from several different first data processing means each associated with a different entity that processes transactions with payment cards.

9. A method for managing the generation and the collection of financial contributions from holders of payment cards for distributing the collected contributions among a plurality of beneficiaries selected by the cardholders, in a management system according to claim 1, the method comprising issuing new cards each associated with a unique identification that is associated with a contribution factor chosen by the cardholder, and/or associating with the unique identification of existing issued cards, a contribution factor chosen by the cardholder.

10. The method of claim 9, which further comprises:
storing, in said first data processing means, data on the contribution factors along with the unique identifications of the respective payment cards;
said first data processing means generating, for each cardholder having a payment card associated with a contribution factor, output data indicating a cardholder contribution that is a proportion of the value of transactions made by the cardholder according to a level set by the contribution factor associated with the card;
treating the cardholder-contribution output data from said first data processing means as a merchant account, or delivering or charging said cardholder-contribution output data to a merchant account held by a contributions management entity
whereby the cardholder contributions are payable by data transfer to the contributions management entity via its merchant account; and
transferring cardholder-contribution output data from said first data processing means to the contributions management entity.

11. The method of claim 10, wherein the payment card system provides, from the cardholder contribution output data provided by the first processing means, an indication of the cardholders contributions along with the periodic statements of transactions made by a cardholder with a payment card associated with a contribution factor.

12. A method for managing the distribution of collected contributions among a plurality of beneficiaries selected by the cardholders, in a management system according to claim 1, the method comprising receiving and processing on the second data processing means of the contributions management entity:
data on the unique identifications of the payment cards associated with contribution factors,
cardholder-contribution output data from said first data processing means,
beneficiary data that identifies a plurality of beneficiaries, and
distribution data indicating those beneficiaries that have been selected by the cardholders, and where needed a distribution amongst two or more beneficiaries selected by a cardholder, this distribution data being associated with the unique identifications of respective payment cards;
and outputting data from the second data processing means, which output data represents a distribution to the different beneficiaries of the contributions made by different cardholders according to said distribution data.

13. The method of claim 12, wherein said second processing means supplies its output data to a series of databanks each representing a fund, each fund having a given nominal value and being closed when the nominal value is reached, said output data determining the share in each fund of different beneficiaries, and closing each fund for a period of time during which the fund is managed by or on behalf of the contributions management entity, the final value of the fund being distributable to the beneficiaries in accordance with their share.

14. The method of claim 12, wherein said second processing means supplies its output data to a series of databanks each representing a fund and each in the name of one beneficiary.

15. A method of generating financial contributions from cardholders for distributing the collected contributions among a plurality of beneficiaries selected by the cardholders, in a management system according to claim 1, the method comprising the following steps taken by a cardholder holding a payment card associated with a contribution factor that is selected by the cardholder, representing the cardholder's selected level of contribution to be made in proportion to the amount of transactions made with the card:
making transactions with the card in order to generate contributions in proportion to the transactions made using the cards; and
constituting or updating said distribution data of the second processing means using said data input means of the management system to select one or more beneficiaries or to alter the selection of beneficiaries and where needed to select or to alter the selection of the distribution of contributions amongst two or more selected beneficiaries.

16. A method for managing the generation and the collection of financial contributions from holders of payment cards and for distributing the collected contributions among a plurality of beneficiaries selected by the cardholders, in a management system according to claim 1,
which method is characterized in that it comprises:
(a) issuing a set of payment cards to cardholders, and associating with the unique identification of cards whose cardholders elect to make contributions in proportion to the transactions made using the cards, a contribution factor that is selectable by the cardholder, representing the cardholder's selected level of contribution to be made in proportion to the amount of transactions made with the card;
(b) storing, in said first data processing means, data on the contribution factors along with the unique identifications of the respective cards;
(c) said first data processing means generating, for each cardholder having a payment card whose unique identification is associated with a contribution factor, output data indicating a cardholder contribution that is a proportion of the value of transactions made by the cardholder according to a level set by the contribution factor associated with the card;
(d) treating the cardholder-contribution output data from said first data processing means as a merchant account, or delivering or charging said cardholder-contribution output data to a merchant account, held by a contributions management entity whereby the cardholder contributions are payable by data transfer to the contributions management entity via its merchant account;
(e) receiving and processing in the second data processing means of the contributions management entity:
data on the unique identifications of the payment cards and the associated contribution factors,
cardholder-contribution output data from said first data processing means,
beneficiary data that identifies a plurality of beneficiaries, and
distribution data indicating those beneficiaries that have been selected by the cardholders, and where needed a distribution amongst two or more beneficiaries selected by a cardholder, this distribution data being associated with the unique identifications of respective payment cards;
(f) outputting, from said second data processing means, data which represents a distribution to the different beneficiaries of the contributions made by different cardholders according to said distribution data; and
(g) constituting or updating said distribution data of the second processing means using data input means of the management system that enables cardholders to select one or more beneficiaries or to alter their selection of beneficiaries and where needed to select or to alter the selection of the distribution of contributions amongst two or more selected beneficiaries, all in association with the unique identifications of their cards,
whereby said first processing means of the payment card system is operative to provide data representing contributions proportional to the amounts of transactions at a level selected by each cardholder, and said second data processing means of the contributions processing entity is operative to provide data representing a distribution of the collected contributions amongst the beneficiaries selected by the cardholders.
